(19) United States
(12) Patent Application Publication
(10) Pub. No.: US 2019/0113641 A1
(43) Pub. Date: Apr. 18, 2019

(54) SEISMIC TRAVEL TIME TOMOGRAPHIC INVERSION METHOD BASED ON TWO POINT RAY TRACING

(71) Applicant: SOUTHERN UNIVERSITY OF SCIENCE AND TECHNOLOGY, Shenzhen (CN)

(72) Inventors: Xinding FANG, Shenzhen (CN); Xiaofei CHEN, Shenzhen (CN)

(21) Appl. No.: 15/950,350

(22) Filed: Apr. 11, 2018

Related U.S. Application Data
(63) Continuation-in-part of application No. PCT/CN2017/105817, filed on Oct. 12, 2017.

(51) Int. Cl. G01V 1/30

(52) U.S. Cl. CPC G01V 1/305; G01V 2210/6222; G01V 2210/671

(57) ABSTRACT

The present application provides a seismic travel time tomographic inversion method based on two-point ray tracing comprising: collecting seismic data including direct wave travel time and reflected wave travel time; establishing an initial one-dimensional continuously layered model having continuously a varying intraformational velocity; representing a ray parameter p by a variable q, representing a source-receiver distance X by a function X=f(q) of the variable q, solving the function X=f(q) using a Newton iteration method; calculating a theoretical direct wave travel time and reflected wave travel time according to the ray parameter p; comparing the calculated theoretical arrival time with actual arrival time, using an optimal algorithm to adjust velocity parameters of the initial one-dimensional continuously layered model, until a difference between the theoretical direct wave travel time and reflected wave travel time and the actual direct wave travel time and reflected wave travel time complies with a predetermined error standard.

### CROSS REFERENCE TO RELATED APPLICATIONS

This US patent application is a continuation-in-part of PCT patent application which is filed on Oct. 12, 2017 and assigned with the PCT application number of PCT/CN2017/105817. The contents of the PCT application are incorporated herein by reference in its entirety.

### TECHNICAL FIELD

The present application relates to the technical field of seismic exploration, and more particularly, relates to a seismic travel time tomographic inversion method based on two-point ray tracing.

### BACKGROUND & SUMMARY

Seismic tomographic imaging is referred to as a method for using seismic observation data to invert the subsurface velocity structure of a target area. The principle of seismic tomographic imaging is similar to medical CT (Computed Tomography) technology. Seismic tomographic imaging is a geographical prospecting interpretation method of performing inversion computation for travel time or waveform of seismic waves propagating in rock or soil mass media, and reestablishing images of velocity distribution of rock or soil mass in a detection range, thereby achieving determining a stratum structure or delineating geological anomalous bodies according to the theory of seismic wave propagation in stratum media. Ray tracing methods based on the ray theory are one kind of forward modeling algorithms. Because ray tracing methods are based on high frequency approximation that assumes a wave travels as a ray from a source point to a receiver point, so they are computationally inexpensive. An inversion process usually adopts an optimal algorithm such as a steepest descent method, a conjugate gradient inversion, a Newton iteration method, a random search method, etc. to solve an optimal solution that complies with a minimum error criterion.

When stratum velocity varies in the depth direction, and is invariant in the horizontal direction, seismic tomographic imaging can use a one-dimensional velocity model to describe the velocity structure of the target area, that is, the velocity is only a function of depth. In a tomographic imaging problem of near-surface shallow layers, one-dimensional model approximation can be used for stratum velocity variation in a small region range. A seismic tomographic imaging method based on the one-dimensional model is commonly used in engineering seismic exploration because of low seismic data sampling density. As for the existing one-dimensional travel time tomographic velocity inversion, supposing that intraformational velocity in each layer is homogeneous, a layered velocity model is obtained by performing an iteration calculation. Generally, the subsurface stratum needs to be divided into a significant number of fine layers with constant layer velocity such that the characteristics of actual stratum velocity variations can be described accurately. The velocity of stratum varies with depth in most situations and may have a continuously varying characteristic, therefore, there exists an inherent approximation in a result obtained by using existing techniques. Moreover, the more the number of the layers, the more the amount of model parameters that need to be inverted, and thus the higher the computational cost for seismic tomographic imaging. In addition, under a condition of a large incident angle (this condition takes place when the distance between a seismic source and a receiver is much larger than the reflection depth of a seismic signal), there exists a problem of slow convergence or non-convergence in the use of two-point ray tracing Newton iteration method in the existing techniques.

A purpose of example embodiments of the present application is to provide a seismic travel time tomographic inversion method based on two-point ray tracing, which aims at solving a problem in the prior art that seismic tomographic imaging is computationally intensive, and the existing two-point travel time ray tracing Newton iteration method causes slow convergence or non-convergence.

An example embodiment of the present application is implemented as a seismic travel time tomographic inversion method based on two-point ray tracing comprising:

obtaining direct wave travel time data and reflected wave travel time data by collecting seismic data in a research area;

performing model parameterizing for the research area, establishing an initial one-dimensional continuously layered model having a continuously varying intraformational velocity;

representing a ray parameter p by a variable q according to the one-dimensional continuously layered model having the continuously varying intraformational velocity, representing a horizontal source-receiver distance X by a function X=f(q) of the variable q, solving the function X=f(q) by using a Newton iteration method, thereby obtaining the ray parameter p, a ray path is determined solely by the ray parameter p; obtaining theoretical direct wave travel time and reflected wave travel time by calculation after the parameter p is obtained;

comparing the calculated theoretical direct wave travel time and reflected wave travel time with actual direct wave travel time and reflected wave travel time obtained by collecting the seismic data; determining whether a difference between the theoretical direct wave travel time and reflected wave travel time and the actual direct wave travel time and reflected wave travel time obtained by collecting the seismic data complies with a predetermined error standard; if yes, outputting the one-dimensional continuously layered model having the continuously varying intraformational velocity, otherwise, performing a next step;

adjusting the one-dimensional continuously layered model having the continuously varying intraformational velocity by an optimal algorithm, until the calculated difference between the theoretical direct wave travel time and reflected wave travel time and the actual direct wave travel time and reflected wave travel time obtained by collecting the seismic data complies with the predetermined error standard, and outputting the model. Further, in the one-dimensional continuously layered model having the continuously varying intraformational velocity, Vₖ is a function of the depth z, the velocity function of the k-th layer is represented as:

Vₖ=aₖz+bₖ,

wherein, a subscript k represents the k-th layer, aₖ and bₖ are model parameters that need to be inverted, and represent the gradient and the intercept of the function of the k-th layer respectively, when an underground compressional wave velocity model is inverted, the intraformational velocity Vₖ is a compressional wave velocity; when an underground shear wave velocity model is inverted, the intraformational velocity Vₖ is the shear wave velocity; when an underground converted wave velocity model is inverted, the intraformational velocity Vₖ is determined to be the compressional wave or the shear wave velocity by the attribute of the converted wave, which can be a shear-to-compressional converted wave or a compressional-to-shear converted wave.

Furthermore, when aₖ=0, the k-th layer of the one-dimensional continuously layered model having the continuously varying intraformational velocity is a homogeneous layer having a constant intraformational velocity.

Furthermore, the source-receiver distance X is represented as a function of the ray parameter p according to Snell's law, and is formulated as:

$$X = {\sum }_{k = 0}^{n} [ {δ}_{k}^{( a )} \frac{{μ}_{k}}{{a}_{k}} ( \sqrt{{p}^{2} - {ɛ}_{k}} - \sqrt{{p}^{- 2} - {ω}_{k}} ) + ( 1 - {δ}_{k}^{( a )} ) \frac{{μ}_{k} {h}_{k}}{\sqrt{{p}^{- 2} - {ɛ}_{k}}} ]$$

wherein, each of coefficients is defined as follow:

$${ɛ}_{k} = \{ \begin{matrix}{( {a}_{k} {z}^{( k - 1 )} + {b}_{k} )}^{2} & k = 1 , 2 , … , n \\ {( {a}_{s} {z}^{( s - 1 )} + {b}_{s} )}^{2} & k = 0\end{matrix} ; \\ {ω}_{k} = \{ \begin{matrix}{( {a}_{k} {z}^{( k )} + {b}_{k} )}^{2} & k = 1 , 2 , … , n \\ {( {a}_{s} {z}_{s} + {b}_{s} )}^{2} & k = 0\end{matrix} ; \\ {h}_{k} = \{ \begin{matrix}( {a}_{k} {z}^{( k - 1 )} + {b}_{k} ) ( {z}^{( k )} - {z}^{( k - 1 )} ) & k = 1 , 2 , … , n \\ ( {a}_{s} {z}^{( s - 1 )} + {b}_{s} ) ( {z}_{s} - {z}^{( s - 1 )} ) & k = 0\end{matrix} ; \\ {μ}_{k} = \{ \begin{matrix}1 & k = 1 , … , s - 1 & ( all waves ) \\ 0 & k = s , … , n & ( direct wave ) \\ 2 & k = s , … , n & ( reflected wave ) \\ 1 - {μ}_{s} & k = 0 & \end{matrix} ; \\ {δ}_{k}^{( a )} = \{ \begin{matrix}1 & {a}_{k} \neq 0 \\ 0 & {a}_{k} = 0\end{matrix}$$

wherein, εₖ, ωₖ, hₖ, μₖ and δₖ are intermediate parameters, a subscripts represents the layer where the seismic source is located and has a value range of (1, n), n represents a label of the layer where reflection of a reflected wave occurs, Zₛ is the depth of the seismic source, z^{(k)} represents the depth of the k-th layer, a subscript k represents the k-th layer, the term k=0 is a correction term regarding the location of the seismic source.

Furthermore, the ray parameter p is represented by a variable q as

$$p = \sqrt{\frac{{q}^{2}}{{V}_{M}^{2} ( 1 + {q}^{2} )}} ,$$

wherein, V_{M} represents the fastest velocity of the ray path passing through the layers.

Furthermore, representing the source-receiver distance X as a function of the variable q, the source-receiver distance X is represented as:

$$X = {\sum }_{k = 0}^{n} [ {δ}_{k}^{( a )} {\tilde{μ}}_{k} ( \sqrt{{q}^{- 2} + {\tilde{ɛ}}_{k}} - \sqrt{{q}^{- 2} + {\tilde{ω}}_{k}} ) + ( 1 - {δ}_{k}^{( a )} ) \frac{{\tilde{h}}_{k}}{\sqrt{{q}^{- 2} + {\tilde{ɛ}}_{k}}} ]$$

wherein, each of coefficients is defined as follows:

$${\tilde{μ}}_{k} = \frac{{μ}_{k} {V}_{M}}{{a}_{k}} ;$$

$${\tilde{h}}_{k} = \frac{{μ}_{k} {h}_{k}}{{V}_{M}} ;$$

$${\tilde{ɛ}}_{k} = 1 - \frac{{ɛ}_{k}}{{V}_{M}^{2}} ;$$

$${\tilde{ω}}_{k} = 1 - \frac{{ω}_{k}}{{V}_{M}^{2}} ,$$

Presetting the source-receiver distance X, using a Newton iteration method to solve X=f(q) so as to obtain a value of the parameter q, and substituting the parameter q back to a relational equation

$$p = \sqrt{\frac{{q}^{2}}{{V}_{M}^{2} ( 1 + {q}^{2} )}}$$

of the ray parameter p, thereby obtaining the value of the ray parameter p.

Furthermore, when the Newton iteration method is used to solve the equation X=f(q), an initial value of q can be obtained by a method as follows:

approximating the source-receiver distance X to the variable q using a rational function formula, the rational function formula is expressed as:

$$X = \frac{{α}_{1} q + {α}_{2} {q}^{2}}{1 + {β}_{1} q + {β}_{2} {q}^{2}}$$

wherein, coefficients α₁, α₂, β₁ and β₂ are obtained by equating the coefficients of the Taylor series of the equation of source-receiver distance X and the rational function formula at q→0 and q→∞. An initial estimate of q is obtained as:

$$q = \frac{{β}_{1} X - {α}_{1} + \sqrt{( {β}_{1}^{2} - 4 {β}_{2} ) {X}^{2} + 2 ( 2 {α}_{2} - {α}_{1} {β}_{1} ) X + {α}_{1}^{2}}}{2 ( {α}_{2} - {β}_{2} X )} ,$$

wherein, expressions of coefficients α₁, α₂, β₁ and β₂ are respectively as follows:

$${α}_{1} = {\sum }_{k = 0}^{n} [ {δ}_{k}^{( a )} \frac{1}{2} {\tilde{μ}}_{k} ( {\tilde{ɛ}}_{k} - {\tilde{ω}}_{k} ) + ( 1 - {δ}_{k}^{( a )} ) {\tilde{h}}_{k} ] ;$$

$${α}_{2} = \frac{{c}_{0} ( {c}_{0}^{2} + {dc}_{- 1} )}{{c}_{- 1}^{2} - {c}_{0} {c}_{- 2}} ;$$

$${β}_{1} = \frac{{c}_{0} {c}_{- 1} + {dc}_{- 2}}{{c}_{0} {c}_{- 2} - {c}_{- 1}^{2}} ;$$

$${β}_{2} = \frac{{c}_{0}^{2} + {dc}_{- 1}}{{c}_{- 1}^{2} - {c}_{0} {c}_{- 2}} ;$$

$${c}_{0} = {\sum }_{k = 0}^{n} [ {δ}_{k}^{( a )} {\tilde{μ}}_{k} ( {δ}_{k}^{( ɛ )} \sqrt{{\tilde{ɛ}}_{k}} - {δ}_{k}^{( ω )} \sqrt{{\tilde{ω}}_{k}} ) + ( 1 - {δ}_{k}^{( a )} ) {δ}_{k}^{( ɛ )} \frac{{\tilde{h}}_{k}}{\sqrt{{\tilde{ɛ}}_{k}}} ] ;$$

$${c}_{1} = {\sum }_{k = 0}^{n} [ ( 1 - {δ}_{k}^{( a )} ) ( 1 - {δ}_{k}^{( ɛ )} ] {\tilde{h}}_{k} ] ;$$

$${c}_{- 1} = {\sum }_{k = 0}^{n} [ {δ}_{k}^{( a )} ( {δ}_{k}^{( ω )} - {δ}_{k}^{( ɛ )} ) {\tilde{μ}}_{k} ] ;$$

$${c}_{- 2} = {\sum }_{k = 0}^{n} [ {δ}_{k}^{( a )} \frac{1}{2} {\tilde{μ}}_{k} ( \frac{{δ}_{k}^{( ɛ )}}{\sqrt{{\tilde{ɛ}}_{k}}} - \frac{{δ}_{k}^{( ω )}}{\sqrt{{\tilde{ω}}_{k}}} ) - ( 1 - {δ}_{k}^{( a )} ) {δ}_{k}^{( ɛ )} \frac{{\tilde{h}}_{k}}{2 {\tilde{ɛ}}_{k}^{3 \text{/} 2}} ] ;$$

$${δ}_{k}^{( ɛ )} = \{ \begin{matrix}1 & {\tilde{ɛ}}_{k} \neq 0 \\ 0 & {\tilde{ɛ}}_{k} = 0\end{matrix} ; \\ {δ}_{k}^{( ω )} = \{ \begin{matrix}1 & {\tilde{ω}}_{k} \neq 0 \\ 0 & {\tilde{ω}}_{k} = 0\end{matrix} ;$$

using the initial value estimation formula of q to obtain an initial value, performing iterative computation, and obtaining an accurate solution of q after the iteration.

Furthermore, a calculation formula of the direct wave travel time and the reflected wave travel time is expressed as:

$$T = {\sum }_{k = 0}^{n} [ {δ}_{k}^{( a )} \frac{{μ}_{k}}{{a}_{k}} ln ( \sqrt{\frac{{ω}_{k}}{{ɛ}_{k}}} \times \frac{1 + \sqrt{1 - {ɛ}_{k} {p}^{2}}}{1 + \sqrt{1 - {ω}_{k} {p}^{2}}} ) + ( 1 - {δ}_{k}^{( a )} ) \frac{{μ}_{k} {h}_{k}}{{ɛ}_{k} \sqrt{1 - {ɛ}_{k} {p}^{2}}} ]$$

Furthermore, a step of collecting seismic data in the research area particularly comprises:

prospecting seismic signals on the earth's surface, wherein both a seismic source and an array of receivers are arranged at the earth's surface; or

vertical seismic profiling, wherein the seismic source is located at the earth's surface, an array of receivers is located in a borehole; or

vertical seismic profiling, wherein the seismic source is located in a borehole, the receiver array is located at the earth's surface; or

cross-well tomographic imaging, wherein the seismic source and the receiver array are located in different wells.

Furthermore, the seismic signal used for seismic travel time tomographic inversion can be compressional wave, or shear wave, or compressional-to-shear converted wave, or shear-to-compressional converted wave.

The seismic travel time tomographic inversion method based on the two-point ray tracing approach provided by non-limiting embodiments of the present application has advantages as follows: by establishing the one-dimensional continuously layered model having the continuously varying stratum velocity, the amount of inversion of variables based on this one-dimensional continuously layered model can be greatly reduced, such that an actual stratum velocity structure can be described more accurately, the computational efficiency of inversion can be improved significantly; by representing the ray parameter p by the variable q, the ray parameter p can be solved by the variable q indirectly, such that the iteration solving process converges rapidly and stably, and a problem of iteration non-convergence occurring under the condition of a large incident angle can be avoided effectively.

In the present application, by establishing the one-dimensional continuously layered model having continuously varying stratum velocity, the number of required model layers can be greatly reduced, such that an actual stratum velocity structure can be described more accurately, the computational efficiency of iteration can be improved; moreover, by using the variable q to solve the ray parameter p, it is ensured that a convergence can be performed fast and stably under the condition of a large incident angle.

### BRIEF DESCRIPTION OF THE DRAWINGS

These and other features and advantages will be better and more completely understood by referring to the following detailed description of non-limiting example embodiments in conjunction with the drawings, of which;

FIG. 1 illustrates a flow chart of a seismic travel time tomographic inversion method based on two-point ray tracing provided by one example embodiment of the present application;

FIG. 2 illustrates a parameter definition of a continuously layered model of the seismic travel time tomographic inversion method based on two-point ray tracing provided by the example embodiment of the present application;

FIG. 3 illustrates a schematic view of a stratum model of the seismic travel time tomographic inversion method based on two-point ray tracing provided by the example embodiment of the present application;

FIG. 4 illustrates a schematic view of collecting seismic exploration surface data in the seismic travel time tomographic inversion method based on two-point ray tracing provided by the example embodiment of the present application;

FIG. 5 illustrates a schematic view of earth surface shooting vertical seismic profiling in the seismic travel time tomographic inversion method based on two-point ray tracing provided by the example embodiment of the present application;

FIG. 6 illustrates a schematic view of downhole shooting vertical seismic profiling in the seismic travel time tomographic inversion method based on two-point ray tracing provided by the example embodiment of the present application;

FIG. 7 illustrates a schematic view of cross-well imaging in the seismic travel time tomographic inversion method based on two-point ray tracing provided by the example embodiment of the present application.

### DETAILED DESCRIPTION OF THE PREFERRED EMBODIMENTS

In order to make the purpose, the technical solution and the advantages of the present application be clearer and more understandable, the present application will be further described in detail below with reference to accompanying figures and example embodiments. It should be understood that the specific example embodiments described herein are merely intended to illustrate but not to limit the present application.

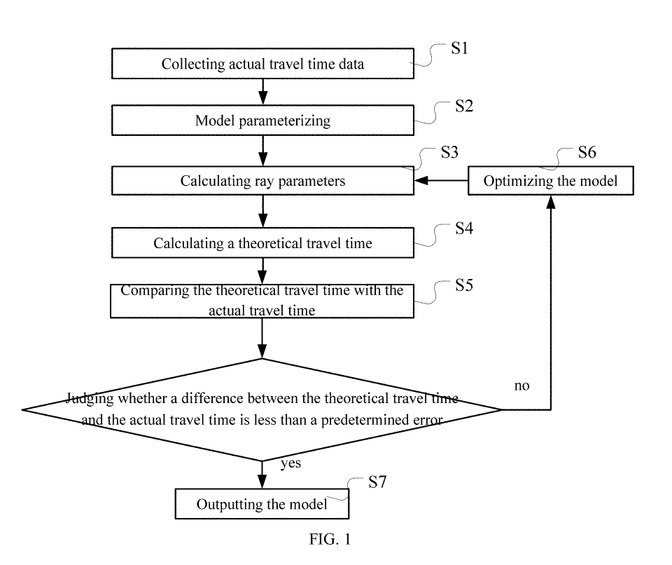

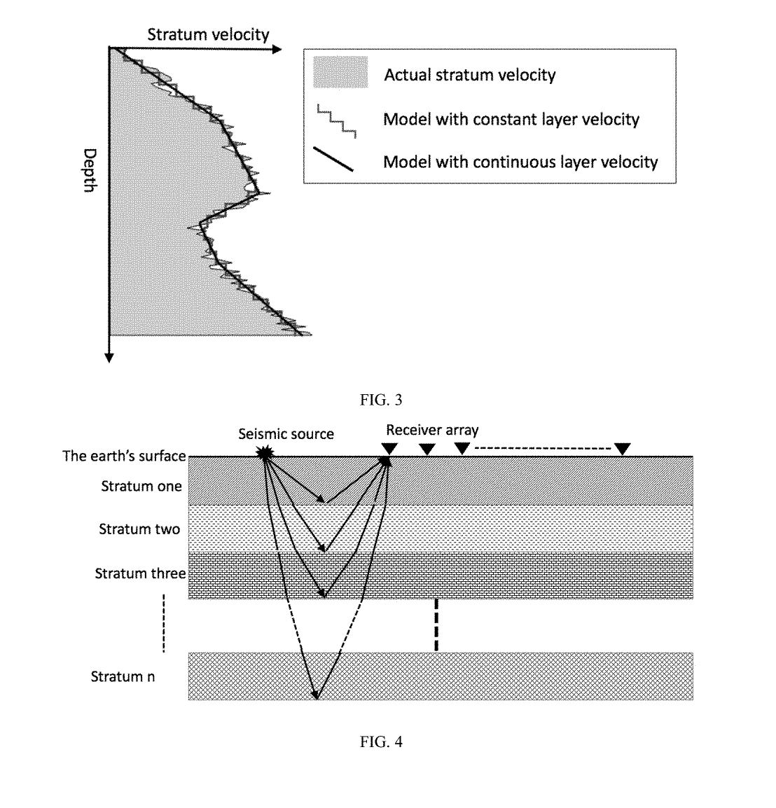

Referring to FIGS. 1-3, an example embodiment of the present application provides a seismic travel time tomographic inversion method based on two-point ray tracing comprising following steps:

step S1, collecting seismic data in a research area. Seismic data is collected in the research area to obtain direct wave travel time data and reflected wave travel time data;

step S2, model parameterizing. Model parameterizing is performed for the research area, and an initial one-dimensional continuously layered model having a continuously varying intraformational velocity is established;

particularly, the intraformational velocity can be a compressional wave velocity or a shear wave velocity, and can be increasing or decreasing with depth;

step S3, computing a ray parameter. A ray parameter p is represented by a variable q according to the one-dimensional continuously layered model having the continuously varying intraformational velocity, a ray parameter p is represented by a variable q, a source-receiver distance Xis represented as a function X=f(q) of the variable q, the function X=f(q) is solved by using a Newton iteration method, thereby obtaining the ray parameter p, a ray path is determined solely by the ray parameter p;

step S4, obtaining theoretical travel time. Direct wave travel time and reflected wave travel time are calculated according to the ray parameter p;

step S5, comparing the theoretical travel time with actual travel time. The calculated direct wave travel time and reflected wave travel time are compared with the actual direct wave travel time and reflected wave travel time obtained by collecting the seismic data; it is determined whether a difference between the theoretical direct wave travel time and reflected wave travel time and the actual direct wave travel time and reflected wave travel time obtained by collecting the seismic data complies with a predetermined error standard; if yes, step S7 is performed, otherwise, a step S6 is performed;

S6, optimizing the model. The one-dimensional continuously layered model having the continuously varying intraformational velocity is adjusted by an optimal algorithm, until the calculated difference between the theoretical direct wave travel time and reflected wave travel time and the actual direct wave travel time and reflected wave travel time complies with the predetermined error standard.

Particularly, the optimal algorithm used can be a steepest descent method, conjugate gradient inversion, a Newton iteration method, a random search method, etc.

S7, outputting the model. When the calculated difference between the theoretical travel time and the actual travel time complies with the predetermined error standard, the model is outputted.

The seismic travel time tomographic inversion method based on two-point ray tracing establishes the one-dimensional continuously layered model having the continuously varying stratum velocity, and represents the intraformational velocity as a function of depth, this model allows intraformational velocities to be continuously varying, reduces the number of required model layers greatly, thereby reducing the amount of inversion variables, such that an actual stratum velocity structure can be described more accurately, the computational efficiency of inversion can be improved significantly. Moreover, the ray parameter p is represented by the variable q, in this way, the ray parameter p can be solved by the variable q indirectly, such that the iteration solving process converges rapidly and stably, and a problem of iteration non-convergence occurring under the condition of a large incident angle can be avoided effectively.

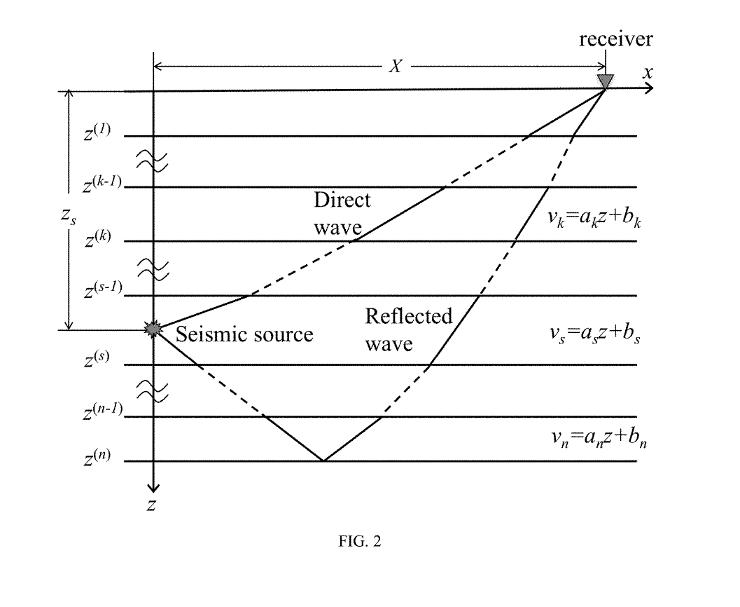

Furthermore, turning now to FIG. 2, in the one-dimensional continuously layered model having the continuously varying intraformational velocity, the intraformational velocity Vₖ is a function of depth z, the velocity function of the k-th layer is formulated as:

Vₖ=aₖz+bₖ,

wherein, a subscript k represents the k-th layer, aₖ and bₖ are model parameters that need to be inverted, and represent the gradient and the intercept of the velocity function of the k-th layer respectively, when an underground compressional wave velocity model is inverted, the intraformational velocity Vₖ is the compressional wave velocity; when an underground shear wave velocity model is inverted, the intraformational velocity Vₖ is the shear wave velocity; when an underground converted wave velocity model is inverted, the intraformational velocity Vₖ is determined to be the compressional wave or the shear wave velocity by the attribute of the converted wave, which can be a shear-to-compressional converted wave or a compressional-to-shear converted wave.

When aₖ=0, it means that the k-th layer is a homogeneous layer having a constant intraformational velocity.

Furthermore, the source-receiver distance X is represented as a function of the ray parameter p according to Snell's law, and is formulated as:

$$X = {\sum }_{k = 0}^{n} [ {δ}_{k}^{( a )} \frac{{μ}_{k}}{{a}_{k}} ( \sqrt{{p}^{2} - {ɛ}_{k}} - \sqrt{{p}^{- 2} - {ω}_{k}} ) + ( 1 - {δ}_{k}^{( a )} ) \frac{{μ}_{k} {h}_{k}}{\sqrt{{p}^{- 2} - {ɛ}_{k}}} ]$$

wherein, each of coefficients is defined as follow:

$${ɛ}_{k} = \{ \begin{matrix}{( {a}_{k} {z}^{( k - 1 )} + {b}_{k} )}^{2} & k = 1 , 2 , … , n \\ {( {a}_{s} {z}^{( s - 1 )} + {b}_{s} )}^{2} & k = 0\end{matrix} ; \\ {ω}_{k} = \{ \begin{matrix}{( {a}_{k} {z}^{( k )} + {b}_{k} )}^{2} & k = 1 , 2 , … , n \\ {( {a}_{s} {z}_{s} + {b}_{s} )}^{2} & k = 0\end{matrix} ; \\ {h}_{k} = \{ \begin{matrix}( {a}_{k} {z}^{( k - 1 )} + {b}_{k} ) ( {z}^{( k )} - {z}^{( k - 1 )} ) & k = 1 , 2 , … , n \\ ( {a}_{s} {z}^{( s - 1 )} + {b}_{s} ) ( {z}_{s} - {z}^{( s - 1 )} ) & k = 0\end{matrix} ; \\ {μ}_{k} = \{ \begin{matrix}1 & k = 1 , … , s - 1 & ( all waves ) \\ 0 & k = s , … , n & ( direct wave ) \\ 2 & k = s , … , n & ( reflected wave ) \\ 1 - {μ}_{s} & k = 0 & \end{matrix} ; \\ {δ}_{k}^{( a )} = \{ \begin{matrix}1 & {a}_{k} \neq 0 \\ 0 & {a}_{k} = 0\end{matrix}$$

wherein, εₖ, ωₖ, hₖ, μₖ and δₖ are intermediate parameters, a subscripts represents a layer where the seismic source is located and has a value range of (1, n), n represents a label of the layer where a reflection of the reflected wave occurs, Zₛ is the depth of the seismic source, z^{(k)} represents the depth of the k-th layer, a subscript k represents the k-th layer, the term k=0 is a correction term regarding the location of the seismic source.

Furthermore, in order to avoid a problem that the iteration non-convergence occurs under the condition of a large incident angle, the ray parameter p is represented by a variable q as

$$p = \sqrt{\frac{{q}^{2}}{{V}_{M}^{2} ( 1 + {q}^{2} )}} ,$$

wherein, V_{M} represents the fastest velocity of the ray path passing through the layers.

Furthermore, presenting the source-receiver distance X as a function of the variable q, the source-receiver distance X is represented as:

$$X = {\sum }_{k = 0}^{n} [ {δ}_{k}^{( a )} {\tilde{μ}}_{k} ( \sqrt{{q}^{- 2} + {\tilde{ɛ}}_{k}} - \sqrt{{q}^{- 2} + {\tilde{ω}}_{k}} ) + ( 1 - {δ}_{k}^{( a )} ) \frac{{\tilde{h}}_{k}}{\sqrt{{q}^{- 2} + {\tilde{ɛ}}_{k}}} ]$$

, wherein, each of coefficients is defined as follow:

$${\tilde{μ}}_{k} = \frac{{μ}_{k} {V}_{M}}{{a}_{k}} ;$$

$${\tilde{h}}_{k} = \frac{{μ}_{k} {h}_{k}}{{V}_{M}} ;$$

$${\tilde{ɛ}}_{k} = 1 - \frac{{ɛ}_{k}}{{V}_{M}^{2}} ;$$

$${\tilde{ω}}_{k} = 1 - \frac{{ω}_{k}}{{V}_{M}^{2}} ,$$

presetting the source-receiver distance X, using a Newton iteration method to solve X=f(q) so as to obtain a value of the parameter q, and substituting the parameter q back to a relational equation

$$p = \sqrt{\frac{{q}^{2}}{{V}_{M}^{2} ( 1 + {q}^{2} )}}$$

of the ray parameter p, thereby obtaining a value of the ray parameter p.

Furthermore, when the Newton iteration method is used to solve the equation X=f(q), an initial value of q can be obtained by the following method:

approximating the source-receiver distance X to the variable q using a rational function formula, the rational function formula is expressed as:

$$X = \frac{{α}_{1} q + {α}_{2} {q}^{2}}{1 + {β}_{1} q + {β}_{2} {q}^{2}}$$

wherein, coefficients α₁, α₂ β₁ and β₂ are obtained by equating the coefficients of the Taylor series of the equation of source-receiver distance X and the rational function formula at q→0 and q→∞. An initial estimate of q is obtained as:

$$q = \frac{{β}_{1} X - {α}_{1} + \sqrt{( {β}_{1}^{2} - 4 {β}_{2} ) {X}^{2} + 2 ( 2 {α}_{2} - {α}_{1} {β}_{1} ) X + {α}_{1}^{2}}}{2 ( {α}_{2} - {β}_{2} X )} ,$$

wherein, expressions of coefficients α₁, α₂ β₁ and β₂ are respectively as follows:

$${α}_{1} = {\sum }_{k = 0}^{n} [ {δ}_{k}^{( a )} \frac{1}{2} {\tilde{μ}}_{k} ( {\tilde{ɛ}}_{k} - {\tilde{ω}}_{k} ) + ( 1 - {δ}_{k}^{( a )} ) {\tilde{h}}_{k} ] ;$$

$${α}_{2} = \frac{{c}_{0} ( {c}_{0}^{2} + {dc}_{- 1} )}{{c}_{- 1}^{2} - {c}_{0} {c}_{- 2}} ;$$

$${β}_{1} = \frac{{c}_{0} {c}_{- 1} + {dc}_{- 2}}{{c}_{0} {c}_{- 2} - {c}_{- 1}^{2}} ;$$

$${β}_{2} = \frac{{c}_{0}^{2} + {dc}_{- 1}}{{c}_{- 1}^{2} - {c}_{0} {c}_{- 2}} ;$$

$${c}_{0} = {\sum }_{k = 0}^{n} [ {δ}_{k}^{( a )} {\tilde{μ}}_{k} ( {δ}_{k}^{( ɛ )} \sqrt{{\tilde{ɛ}}_{k}} - {δ}_{k}^{( ω )} \sqrt{{\tilde{ω}}_{k}} ) + ( 1 - {δ}_{k}^{( a )} ) {δ}_{k}^{( ɛ )} \frac{{\tilde{h}}_{k}}{\sqrt{{\tilde{ɛ}}_{k}}} ] ;$$

$${c}_{1} = {\sum }_{k = 0}^{n} [ ( 1 - {δ}_{k}^{( a )} ) ( 1 - {δ}_{k}^{( ɛ )} ] {\tilde{h}}_{k} ] ;$$

$${c}_{- 1} = {\sum }_{k = 0}^{n} [ {δ}_{k}^{( a )} ( {δ}_{k}^{( ω )} - {δ}_{k}^{( ɛ )} ) {\tilde{μ}}_{k} ] ;$$

$${c}_{- 2} = {\sum }_{k = 0}^{n} [ {δ}_{k}^{( a )} \frac{1}{2} {\tilde{μ}}_{k} ( \frac{{δ}_{k}^{( ɛ )}}{\sqrt{{\tilde{ɛ}}_{k}}} - \frac{{δ}_{k}^{( ω )}}{\sqrt{{\tilde{ω}}_{k}}} ) - ( 1 - {δ}_{k}^{( a )} ) {δ}_{k}^{( ɛ )} \frac{{\tilde{h}}_{k}}{2 {\tilde{ɛ}}_{k}^{3 \text{/} 2}} ] ;$$

$${δ}_{k}^{( ɛ )} = \{ \begin{matrix}1 & {\tilde{ɛ}}_{k} \neq 0 \\ 0 & {\tilde{ɛ}}_{k} = 0\end{matrix} ; \\ {δ}_{k}^{( ω )} = \{ \begin{matrix}1 & {\tilde{ω}}_{k} \neq 0 \\ 0 & {\tilde{ω}}_{k} = 0\end{matrix} ;$$

using the initial value estimation formula of q to obtain an initial value, performing iterative computation, and obtaining an accurate solution of q after the iteration. The accuracy of the initial value obtained by this method can be very high, for obtaining the accurate solution of the variable q, the iterative computation only needs to be performed for 1 to 3 times.

Furthermore, after the value of the ray parameter p is obtained, a calculation formula of the direct wave travel time and the reflected wave travel time is expressed as:

$$T = {\sum }_{k = 0}^{n} [ {δ}_{k}^{( a )} \frac{{μ}_{k}}{{a}_{k}} ln ( \sqrt{\frac{{ω}_{k}}{{ɛ}_{k}}} \times \frac{1 + \sqrt{1 - {ɛ}_{k} {p}^{2}}}{1 + \sqrt{1 - {ω}_{k} {p}^{2}}} ) + ( 1 - {δ}_{k}^{( a )} ) \frac{{μ}_{k} {h}_{k}}{{ɛ}_{k} \sqrt{1 - {ɛ}_{k} {p}^{2}}} ]$$

Furthermore, referring to FIGS. 4-7, the collecting seismic data in the research area comprises:

prospecting seismic signals on the earth's surface as shown in FIG. 4, wherein both a seismic source and an array of receivers are arranged at the earth's surface; or

vertical seismic profiling as shown in FIG. 5, wherein a seismic source is located at the earth's surface, an array of receivers is located in a borehole; or

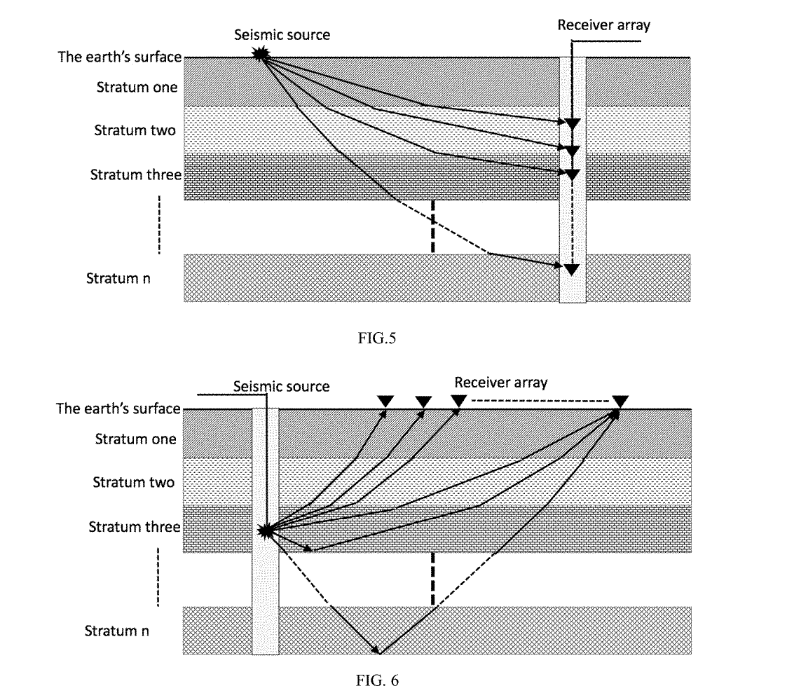

vertical seismic profiling as shown in FIG. 6, wherein a seismic source is located in a borehole, a receiver array is located at the earth's surface; or

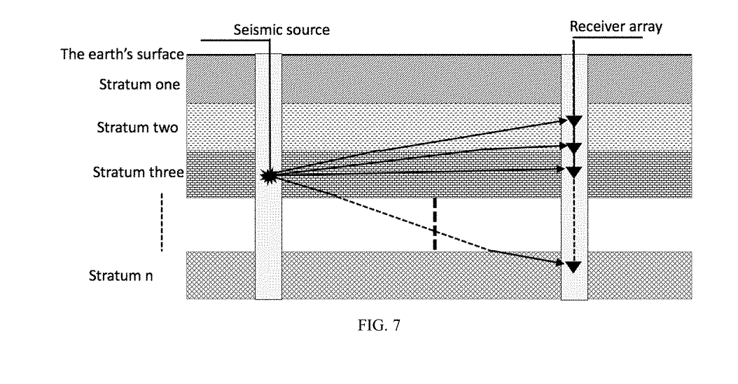

cross-well tomographic imaging as shown in FIG. 7, wherein a seismic source and a receiver array are located in different wells.

Furthermore, the seismic signal used for seismic travel time tomographic inversion can be a compressional wave, or a shear wave, or a compressional-to-shear converted wave, or a shear-to-compressional converted wave.

The aforementioned example embodiments are only preferred embodiments of the present invention, and should not be regarded as limiting the present invention. Rather, the invention(s) is/are defined by the claims. Any modification, equivalent replacement, improvement, and so on, which are made within the spirit and the principle of the present invention, should be included in the protection scope of the present invention.

What is claimed is:

1. A seismic travel time tomographic inversion method based on two-point ray tracing, comprising:
obtaining direct wave travel time data and reflected wave travel time data by collecting seismic data in a research area;
performing model parameterizing for the research area, establishing an initial one-dimensional continuously layered model having a continuously varying intraformational velocity;
representing a ray parameter p by a variable q according to the one-dimensional continuously layered model having the continuously varying intraformational velocity, representing a source-receiver distance X by a function X=f(q) of the variable q, solving the function X=f(q) by using a Newton iteration method, thereby obtaining the ray parameter p, a ray path is determined solely by the ray parameter p; calculating a theoretical direct wave travel time and reflected wave travel time after the parameter p is obtained;
comparing the calculated theoretical direct wave travel time and reflected wave travel time with actual direct wave travel time and reflected wave travel time obtained by collecting the seismic data; determining whether a difference between the theoretical direct wave travel time and reflected wave travel time and the actual direct wave travel time and reflected wave travel time obtained by collecting the seismic data complies with a predetermined error standard; if yes, outputting the one-dimensional continuously layered model having the continuously varying intraformational velocity, if no, performing a next step;
adjusting the one-dimensional continuously layered model having the continuously varying intraformational velocity by an optimal algorithm, until the calculated difference between the theoretical direct wave travel time and reflected wave travel time and the actual direct wave travel time and reflected wave travel time obtained by collecting the seismic data complies with the predetermined error standard, and outputting the one-dimensional continuously layered model having the continuously varying intraformational velocity.

2. The seismic travel time tomographic inversion method based on two-point ray tracing according to claim 1, wherein, in the one-dimensional continuously layered model having the continuously varying intraformational velocity, Vₖ is a function of the depth z, the velocity function of the k-th layer is represented as:
Vₖ=aₖz+bₖ,
wherein, a subscript k represents the k-th layer, aₖ and bₖ are model parameters that need to be inverted, and represent the gradient and the intercept of the velocity function of the k-th layer respectively, when an underground compressional wave velocity model is inverted, the intraformational velocity Vₖ is a compressional wave velocity; when an underground shear wave velocity model is inverted, the intraformational velocity Vₖ is the shear wave velocity; when an underground converted wave velocity model is inverted, the intraformational velocity Vₖ is determined to be a compressional wave velocity or a shear wave velocity by the attribute of the converted wave, which can be a shear-to-compressional converted wave or a compressional-to-shear converted wave.

3. The seismic travel time tomographic inversion method based on two-point ray tracing according to claim 2, wherein, when aₖ=0, the k-th layer of the one-dimensional continuously layered model having the continuously varying intraformational velocity is a homogeneous layer having a constant intraformational velocity.

4. The seismic travel time tomographic inversion method based on two-point ray tracing according to claim 1, wherein, the source-receiver distance X is represented as a function of the ray parameter p according to Snell's law, and is formulated as:
$$X = {\sum }_{k = 0}^{n} [ {δ}_{k}^{( a )} \frac{{μ}_{k}}{{a}_{k}} ( \sqrt{{p}^{2} - {ɛ}_{k}} - \sqrt{{p}^{- 2} - {ω}_{k}} ) + ( 1 - {δ}_{k}^{( a )} ) \frac{{μ}_{k} {h}_{k}}{\sqrt{{p}^{- 2} - {ɛ}_{k}}} ]$$
wherein, each of coefficients is defined as follow:
$${ɛ}_{k} = \{ \begin{matrix}{( {a}_{k} {z}^{( k - 1 )} + {b}_{k} )}^{2} & k = 1 , 2 , … , n \\ {( {a}_{s} {z}^{( s - 1 )} + {b}_{s} )}^{2} & k = 0\end{matrix} ; \\ {ω}_{k} = \{ \begin{matrix}{( {a}_{k} {z}^{( k )} + {b}_{k} )}^{2} & k = 1 , 2 , … , n \\ {( {a}_{s} {z}_{s} + {b}_{s} )}^{2} & k = 0\end{matrix} ; \\ {h}_{k} = \{ \begin{matrix}( {a}_{k} {z}^{( k - 1 )} + {b}_{k} ) ( {z}^{( k )} - {z}^{( k - 1 )} ) & k = 1 , 2 , … , n \\ ( {a}_{s} {z}^{( s - 1 )} + {b}_{s} ) ( {z}_{s} - {z}^{( s - 1 )} ) & k = 0\end{matrix} ; \\ {μ}_{k} = \{ \begin{matrix}1 & k = 1 , … , s - 1 & ( all waves ) \\ 0 & k = s , … , n & ( direct wave ) \\ 2 & k = s , … , n & ( reflected wave ) \\ 1 - {μ}_{s} & k = 0 & \end{matrix} ; \\ {δ}_{k}^{( a )} = \{ \begin{matrix}1 & {a}_{k} \neq 0 \\ 0 & {a}_{k} = 0\end{matrix}$$
wherein, εₖ, ωₖ, hₖ, μₖ and δₖ are intermediate parameters, a subscripts represents the layer where the seismic source is located and has a value range of (1, n), n represents a label of the layer where a reflection of the reflected wave occurs, Zₛ is the depth of the seismic source, z^{(k)} represents the depth of the k-th layer, a subscript k represents the k-th layer, the term k=0 is a correction term regarding the location of the seismic source.

5. The seismic travel time tomographic inversion method based on two-point ray tracing according to claim 4, wherein, the ray parameter p is represented by a variable q as
$$p = \sqrt{\frac{{q}^{2}}{{V}_{M}^{2} ( 1 + {q}^{2} )}} ,$$
wherein, V_{M} represents the fastest velocity of the ray path passing through the layers.

6. The seismic travel time tomographic inversion method based on two-point ray tracing according to claim 5, wherein, representing the source-receiver distance X as a function of the variable q, the source-receiver distance X is represented as:
$$X = {\sum }_{k = 0}^{n} [ {δ}_{k}^{( a )} {\tilde{μ}}_{k} ( \sqrt{{q}^{- 2} + {\tilde{ɛ}}_{k}} - \sqrt{{q}^{- 2} + {\tilde{ω}}_{k}} ) + ( 1 - {δ}_{k}^{( a )} ) \frac{{\tilde{h}}_{k}}{\sqrt{{q}^{- 2} + {\tilde{ɛ}}_{k}}} ]$$
wherein, each of coefficients is defined as follow:
$${\tilde{μ}}_{k} = \frac{{μ}_{k} {V}_{M}}{{a}_{k}} ;$$
$${\tilde{h}}_{k} = \frac{{μ}_{k} {h}_{k}}{{V}_{M}} ;$$
$${\tilde{ɛ}}_{k} = 1 - \frac{{ɛ}_{k}}{{V}_{M}^{2}} ;$$
$${\tilde{ω}}_{k} = 1 - \frac{{ω}_{k}}{{V}_{M}^{2}} ,$$
presetting the source-receiver distance X, using a Newton iteration method to solve X=f(q) so as to obtain a value of the parameter q, and substituting the parameter q back to a relational equation
$$p = \sqrt{\frac{{q}^{2}}{{V}_{M}^{2} ( 1 + {q}^{2} )}}$$
of the ray parameter p, thereby obtaining the value of the ray parameter p.

7. The seismic travel time tomographic inversion method based on two-point ray tracing according to claim 6, wherein, when the Newton iteration method is used to solve the equation X=f(q), an initial value of q can be obtained by a method as follows:
approximating the source-receiver distance X to the variable q using a rational function formula, the rational function formula is expressed as:
$$X = \frac{{α}_{1} q + {α}_{2} {q}^{2}}{1 + {β}_{1} q + {β}_{2} {q}^{2}}$$
wherein, coefficients α₁, α₂ β₁ and β₂ are obtained by equating the coefficients of the Taylor series of the equation of source-receiver distance X and the rational function formula at q→0 and q→∞. An initial estimate of q is obtained as:
$$q = \frac{{β}_{1} X - {α}_{1} + \sqrt{( {β}_{1}^{2} - 4 {β}_{2} ) {X}^{2} + 2 ( 2 {α}_{2} - {α}_{1} {β}_{1} ) X + {α}_{1}^{2}}}{2 ( {α}_{2} - {β}_{2} X )} ,$$
wherein, expressions of coefficients α₁, α₂ β₁ and β₂ are respectively as follows:
$${α}_{1} = {\sum }_{k = 0}^{n} [ {δ}_{k}^{( a )} \frac{1}{2} {\tilde{μ}}_{k} ( {\tilde{ɛ}}_{k} - {\tilde{ω}}_{k} ) + ( 1 - {δ}_{k}^{( a )} ) {\tilde{h}}_{k} ] ;$$
$${α}_{2} = \frac{{c}_{0} ( {c}_{0}^{2} + {dc}_{- 1} )}{{c}_{- 1}^{2} - {c}_{0} {c}_{- 2}} ;$$
$${β}_{1} = \frac{{c}_{0} {c}_{- 1} + {dc}_{- 2}}{{c}_{0} {c}_{- 2} - {c}_{- 1}^{2}} ;$$
$${β}_{2} = \frac{{c}_{0}^{2} + {dc}_{- 1}}{{c}_{- 1}^{2} - {c}_{0} {c}_{- 2}} ;$$
$${c}_{0} = {\sum }_{k = 0}^{n} [ {δ}_{k}^{( a )} {\tilde{μ}}_{k} ( {δ}_{k}^{( ɛ )} \sqrt{{\tilde{ɛ}}_{k}} - {δ}_{k}^{( ω )} \sqrt{{\tilde{ω}}_{k}} ) + ( 1 - {δ}_{k}^{( a )} ) {δ}_{k}^{( ɛ )} \frac{{\tilde{h}}_{k}}{\sqrt{{\tilde{ɛ}}_{k}}} ] ;$$
$${c}_{1} = {\sum }_{k = 0}^{n} [ ( 1 - {δ}_{k}^{( a )} ) ( 1 - {δ}_{k}^{( ɛ )} ] {\tilde{h}}_{k} ] ;$$
$${c}_{- 1} = {\sum }_{k = 0}^{n} [ {δ}_{k}^{( a )} ( {δ}_{k}^{( ω )} - {δ}_{k}^{( ɛ )} ) {\tilde{μ}}_{k} ] ;$$
$${c}_{- 2} = {\sum }_{k = 0}^{n} [ {δ}_{k}^{( a )} \frac{1}{2} {\tilde{μ}}_{k} ( \frac{{δ}_{k}^{( ɛ )}}{\sqrt{{\tilde{ɛ}}_{k}}} - \frac{{δ}_{k}^{( ω )}}{\sqrt{{\tilde{ω}}_{k}}} ) - ( 1 - {δ}_{k}^{( a )} ) {δ}_{k}^{( ɛ )} \frac{{\tilde{h}}_{k}}{2 {\tilde{ɛ}}_{k}^{3 \text{/} 2}} ] ;$$
$${δ}_{k}^{( ɛ )} = \{ \begin{matrix}1 & {\tilde{ɛ}}_{k} \neq 0 \\ 0 & {\tilde{ɛ}}_{k} = 0\end{matrix} ; \\ {δ}_{k}^{( ω )} = \{ \begin{matrix}1 & {\tilde{ω}}_{k} \neq 0 \\ 0 & {\tilde{ω}}_{k} = 0\end{matrix} ;$$
using the initial value estimation formula of q to obtain initial value, performing iterative computation, and obtaining an accurate solution of q after the iteration.

8. The seismic travel time tomographic inversion method based on two-point ray tracing according to claim 1, wherein, a calculation formula of the direct wave travel time and the reflected wave travel time is expressed as:
$$T = {\sum }_{k = 0}^{n} [ {δ}_{k}^{( a )} \frac{{μ}_{k}}{{a}_{k}} ln ( \sqrt{\frac{{ω}_{k}}{{ɛ}_{k}}} \times \frac{1 + \sqrt{1 - {ɛ}_{k} {p}^{2}}}{1 + \sqrt{1 - {ω}_{k} {p}^{2}}} ) + ( 1 - {δ}_{k}^{( a )} ) \frac{{μ}_{k} {h}_{k}}{{ɛ}_{k} \sqrt{1 - {ɛ}_{k} {p}^{2}}} ]$$

9. The seismic travel time tomographic inversion method based on two-point ray tracing according to claim 1, wherein, the collecting seismic data in the research area is particularly:
prospecting seismic signals on the earth's surface, wherein both a seismic source and an array of receivers are arranged at the earth's surface; or
vertical seismic profiling, wherein a seismic source is located at the earth's surface, an array of receivers is located in a borehole; or
vertical seismic profiling, wherein a seismic source is located in a borehole, a receiver array is located at the earth's surface; or
cross-well tomographic imaging, wherein a seismic source and a receiver array are located in different wells.

10. The seismic travel time tomographic inversion method based on two-point ray tracing according to claim 1, wherein a seismic signal used for seismic travel time tomographic inversion can be a compressional wave, or a shear wave, or a compressional-to-shear converted wave, or a shear-to-compressional converted wave.

11. A system for seismic travel time tomographic inversion based on two-point ray tracing, comprising:
at least one sensor that collects direct wave travel time seismic data and reflected wave travel time seismic data in a research area; and
at least one processor operatively communicating with the sensor, the at least one processor performing the following:
parameterize a model for the research area and establishing an initial one-dimensional continuously layered model having a continuously varying intraformational velocity;
represent a ray parameter p by a variable q according to the one-dimensional continuously layered model, including representing a source-receiver distance X by a function of the variable q, and solving the function by using a Newton iteration method, thereby obtaining the ray parameter p,
determine a ray path solely from the ray parameter p;
calculate a theoretical direct wave travel time and reflected wave travel time once the parameter p is obtained;
compare the calculated theoretical direct wave travel time and reflected wave travel time with direct wave travel time and reflected wave travel time collected by the sensor;
determine whether a difference between the theoretical direct wave travel time and reflected wave travel time and the actual direct wave travel time and reflected wave travel time complies with a predetermined error standard;
if the determining determines a difference between the theoretical direct wave travel time and reflected wave travel time and the actual direct wave travel time and reflected wave travel time complies with a predetermined error standard, output the one-dimensional continuously layered model having the continuously varying intraformational velocity,
if the determining determines a difference between the theoretical direct wave travel time and reflected wave travel time and the actual direct wave travel time and reflected wave travel time does not comply with a predetermined error standard, adjust the one-dimensional continuously layered model;
repeat the comparison, the determining and the adjusting until the calculated difference between the theoretical direct wave travel time and reflected wave travel time and the actual direct wave travel time and reflected wave travel time obtained by collecting the seismic data complies with the predetermined error standard, and
output the one-dimensional continuously layered model having the continuously varying intraformational velocity.

12. A system comprising:
a seismic data sensor that collects direct wave travel time and reflected wave travel time seismic data; and
at least one processor connected to receive the seismic data collected by the sensor, the at least one processor performing the following:
establish a one-dimensional continuously layered model having a continuously varying intraformational velocity;
represent a ray parameter p by a variable q according to the one-dimensional continuously layered model, including representing a source-receiver distance X by a function of the variable q, and solving the function by using a Newton iteration method, thereby obtaining the ray parameter p,
determine a ray path solely from the ray parameter p;
calculate a theoretical direct wave travel time and reflected wave travel time based on the ray parameter p and the determined ray path;
compare the calculated theoretical direct wave travel time and reflected wave travel time with direct wave travel time and reflected wave travel time seismic data collected by the sensor; and
iteratively adjust the one-dimensional continuously layered model based on an iterated comparison until a difference between the theoretical direct wave travel time and reflected wave travel time and the actual direct wave travel time and reflected wave travel time is within a predetermined error tolerance.
